(19) United States
(12) Patent Application Publication
(10) Pub. No.: US 2006/0041205 A1
(43) Pub. Date: Feb. 23, 2006

(54) ISOROM portable isometric and passive range of motion device

(76) Inventor: Larry Dale Ladd JR., Knoxville, TN (US)

Correspondence Address: WILSON ENTERPRISES, 2333 BRIGHTON FARMS BLVD., KNOXVILLE, TN, 37932, US

(21) Appl. No.: 10/919,856

(22) Filed: Aug. 17, 2004

(51) Int. Cl. A61H 1/00

(52) U.S. Cl. 601/5; 601/23; 601/33

(57) ABSTRACT

The ISOROM is a rehabilitation device for both surgical and non-surgical upper extremity/shoulder patients to allow passive range of motion (PROM) and isometric strengthening within isolated ranges of movement. The apparatus is appropriate for continued progression of active assistive range of motion (AAROM) as particular physician protocols allow.

### TECHNICAL FIELD

The invention relates to an apparatus that is used for therapeutic treatment of a shoulder joint. In particular, the device can be used to regulate isolated passive range of motion of a shoulder and stop in position for isometric exercises. The device is portable and suitable for clinic and home use. The device can impart flexion, extension, elevation, and rotation of the shoulder.

### DESCRIPTION OF THE BACKGROUND ART

Continuous passive motion therapy is used to aid in recovery following joint trauma or surgery and has been found to have beneficial results in the rehabilitation of injured limbs. Passive motion is also used for treatment of other bone and muscular disorders, such as arthritis and muscular dystrophy. Often a physical therapist must apply the passive motion.

Many devices are currently commercially available for application of continuous passive motion to the hip, leg and foot. Examples of devices that cause continuous passive flexion of the elbow and wrist are illustrated in French Pat. No. 2,440,187 to Pecheux, U.S. Pat. No. 3,929,335 to Malick, and U.S. Pat. No. 4,487,199 to Sarringer.

It is more difficult to design a device to impart the desired passive treatment to the shoulder than to the elbow or wrist, in part because of its proximity to the torso, and in part because of the greater range of mobility in the shoulder. Devices for exercising the shoulder joint are shown in U.S. Pat. No. 2,777,439 to Tuttle, U.S. Pat. No. 3,089,700 to Hotas, and U.S. Pat. No. 4,395,039 to Kaiser.

In U.S. Pat. No. 4,669,451, Bleuth et al teach a device for exercising the shoulder joint. The device is secured to the body and is able to exercise the shoulder in a horizontal pivot axis, as well as a vertical pivot axis; which two axes intersect each other in the afflicted shoulder joint. An additional motion generating and transmitting unit can be provided to pivot two articulated connected portions of the arm support in the region of the elbow.

Funk et al in U.S. Pat. No. 4,651,719 describes a lightweight portable device to impart continuous passive motion to a user's shoulder. The device is fashioned to produce abduction, adduction, as well as simultaneous rotation. The device produces continuous passive motion to the shoulder. The device passively produces abduction and adduction of the arm about the shoulder and optionally causes simultaneous rotation of the arm as well. The device is actuated by a mechanical drive mechanism.

A passive shoulder exerciser to move the patient's arm back and forth through an arc to provide flexion and abduction of the shoulder is described by Donovan et al in U.S. Pat. No. 5,179,939. The device is a motor driven passive device.

Randall et al in U.S. Pat. No. 5,335,649 describes a mechanized machine employed in various stretching exercises. Different parts of the body can be exercised.

The shoulder is formed where the clavicle, scapula and humerus join laterally. The joint formed is a ball-and-socket type articulation between the proximal humerus and the glenoid cavity of the scapula. The socket is shallow, and the joint capsule is loose-fitting. As a result of this construction, the joint permits a wide range of motion but the joint is subject to poor stability and strength.

The shoulder is capable of three types of motion: abduction and adduction, flexion and extension, and rotation. Abduction and adduction is movement of the arm away from and toward the median axis, or long axis, in the median plane of the body. The median plane of the body is defined by the front or back of the body in a straight position. Abduction is movement away from the median axis, such as raising an arm laterally or sideways. Adduction is the opposite movement, i.e., movement toward the median axis of the body. Flexion means moving the arm forward and upward or backward and upward to increase the angle between the arm and the median plane of the body. Extension is the opposite motion of flexion, i.e., movement toward the median plane of the body. Rotation is turning the arm about its long axis as if on a pivot. External rotation is rotation away from the median axis of the body and internal rotation is rotation toward the median axis of the body. Following shoulder surgery, it is desirable to recover flexion, extension and rotation in the shoulder joint.

The ISOROM presents a device for passively inducing flexion and extension of the arm about the shoulder while lying supine. The device is positioned for the patient to lie adjacent the frame. The hub is aligned with the rotational axis of the patients shoulder. It exercises the shoulder by elevating the upper arm and forearm supports, which pushes the patients arm upward causing abduction, external rotation, and elevation. The device supports the weight of the patient's arm thereby allowing lifting assistance from the patients other arm, a mechanical lifting device, or another human assistant. The device permits variable angles of elevation with the patient controlling parameters such as speed of movement, duration of hold/stretch, degrees of movement, and repetitions.

Another feature of rehabilitation devices that is desirable is portability. The ISOROM may be transported from room to room or taken home in order to enable different patients to share a CPM machine or perform home therapy. The ISOROM may be transported within the clinical setting or be used in home physical therapy or during patient home exercises as instructed by the therapist/physician.

Another advantage of the ISOROM is the adjustable pivot arm extension with rotation to accommodate proper angles based on patient size and desired position during elevation.

It is a further advantage to present an ISOROM unit that can be easily adapted for use with the right shoulder as well as the left shoulder.

It is also of advantage to provide an ISOROM unit that can be adjusted according to the angle of flexion desired at the elbow, and to adapt to patients of varying size and shape.

A further advantage of the ISOROM is the measured rotational or epicyclic angles for reporting progress and controlling motion.

A further advantage of the ISOROM is the ability to operate with or without mechanical lift and drop assistance.

Yet another advantage of the ISOROM is that motion is patient controlled and can be started and stopped at specific incremental positions.

Finally, in the interests of safety, it is an advantage for the ISOROM device to be designed so that a minimum of the actuator mechanism is exposed.

### SUMMARY OF THE INVENTION

The ISOROM is a rehabilitation device for both surgical and non-surgical upper extremity/shoulder patients to allow passive range of motion (PROM) and isometric strengthening within isolated ranges of movement. The apparatus is appropriate for continued progression of active assistive range of motion (AAROM) as particular physician protocols allow. There are various devices in the rehabilitation equipment market that have limitations such as cost, benefits, and actual performance of desired activities. Opportunities for use are high considering the number of surgical and non-surgical upper extremity cases in the orthopedic industry.

A portable ISOROM device is taught comprising a base, a frame removably coupled with the base, a pivot arm support removably coupled with the frame, a pivot arm removably coupled with the pivot arm support and selectively engaged with the frame at preselected epicyclic intervals corresponding with a range of motion in a patient shoulder, and a pivot arm extension removably coupled with the pivot arm.

### BRIEF DESCRIPTION OF THE DRAWINGS

FIG. 1 is a sketch of an embodiment of the invention.

FIG. 2 is a sketch of a patient's arm strapped in position for using the invention.

FIG. 3 is a sketch of the bottom portion of the invention.

FIG. 4 is a sketch of a lift-assisted embodiment of the invention.

FIG. 5 is a sketch of a lift-assisted embodiment at 0° or horizontal position.

FIG. 6 is a sketch of an embodiment with an adjustable elbow portion in the pivot arm extension.

### DETAILED DESCRIPTION OF THE INVENTION

The Isometric Range of Motion (ISOROM) device provides a cost effective means of allowing independent exercise performance by the patient/family during the acute/subacute stages of rehabilitation following upper extremity injury and/or surgery. Health insurance limitations, personal schedules, patient apprehension, surgical procedure, and pain levels are factors to consider in the rehab pathway. The rehab cycle has various stages that generally fall in these categories:

Rehab Phases after Surgery

| Time | | Activities |
|---|---|---|
| 0-6 | weeks | Patient Education/Protection/Pain Management/PROM |
| 6-8 | weeks | AAROM/Isometrics/Scapular Stabilization |
| 8-10 | weeks | AROM/Isotonics-dumbbells/Tband |
| 10-12 | weeks | Strengthening Machines/Functional/CKC |
| 12-16 | weeks | Return to Work/Recreational/Athletics |

The initial phase is critical in terms of creating patient confidence in the physician and physical/occupational therapist. Research and physician expertise/training has allowed a speedier progression in the rehab process for many orthopedic diagnoses. However, the need for awareness of further insult to post-operative conditions such as a large rotator cuff tear performed with an open procedure or small to medium tear performed arthroscopically is critical for short and long tem success. Most all cases start with early PROM which allows joint movement with less pain, muscle guarding, and stress to injured tissue. The challenge in performing PROM is usually with patient understanding, avoiding active contraction of surrounding musculature, pain levels during muscle contraction, and apprehension by the patient/family in movement during early stages of recovery, and the surgical procedure. Often, certain ranges of motion cannot be performed to prevent further micro/macro trauma to the repaired structures. This time frame is usually in the first 6-8 weeks after surgery.

The ISOROM device is a more cost effective device allowing post surgical/injury upper extremity patients the ability to perform PROM in a supine position with the patient having control of the progression of range of motion that can be isolated and performed with decreased pain and muscle guarding. The device also allows isolated isometric strengthening as determined by the physician/therapist. The primary motion being performed is elevation.

The device is suitable for outpatient/inpatient use by therapists as well as home use by the patient/family. Development of two devices may be appropriate for continued long-term use in the rehab setting along with a device more applicable for home use via rental or purchase. A primary goal in this area is to conserve visits during the early stages of rehab. The visits will be better used later when skilled therapy for strengthening, functional activities, etc. will be needed. ISOROM is appropriate for a range of diagnoses including post surgery for rotator cuff tears/instability/fracture/total joint replacement, frozen/stiff shoulder syndrome, non-surgical cases for fractures and neurological conditions such as stroke.

ISOROM provides the following benefits: 1) minimize pain while performing home exercises in the first 6-8 weeks of rehab allowing range of motion gains, without stress to the injured/repaired tissue; 2) prevention of stiff shoulder syndrome/frozen shoulder; 3) creation of patient confidence in exercise performance, physician confidence in protection of post-surgical cases while restoring range of motion; 4) allow quicker initiation of AAROM/AROM/Strengthening phases of rehab by obtaining full PROM during the first 6-8 weeks; and 5) overall total costs and number of visits can also be reduced while still achieving long term functional outcomes for the patient.

ISOROM is a more cost effective device and outperforms present expensive equipment in the rehabilitation industry specific to upper extremity range of motion. Current devices are appropriate for use in the hospital setting but are too expensive for rental and use by the patient at home or for purchase in the outpatient setting. The rope/pulley apparatus is relatively inexpensive but PROM performed in the sitting position is against gravity often creating additional pain, scapular compensation with potential for active contraction of shoulder musculature when PROM is desired. In effect, the glenohumeral joint motion may be hindered due to muscular contraction possibly leading to the frozen/stiff shoulder pathway. Performing PROM in a supine position as performed by the physical/occupational therapist in the rehab setting will be achieved with the patient and/or family assisting in gradual/isolated ranges of motion with less pain. The patient has control based on their pain levels and speed. The recovery process of increasing range of motion cannot be entirely achieved by attending therapy even daily to 3 times per week as often prescribed. Costs increase, allowable visits are used up and the therapist often runs out of time to achieve the full potential in the area of strength/function during the 3rd-4th month of recovery. ISOROM enables a mechanism to allow PROM to be initiated and maintained during the early stages of therapist intervention/education and save visits/costs for later stages of rehab. ISOROM achieves less pain during exercise with quicker range of motion gains, less total costs, reduced visits in the early stages of rehab, protection of repaired structures by the physician, improved use of time by the therapist when used in the rehab setting, and a cost effective device that assists in the overall goal of quality functional outcomes for the patient to return to personal desires with daily life, work, recreation, etc. The ISOROM provides: 1) Early PROM performed through gradual/controlled isolated movements; 2) Prevention of undesired active muscle contraction during PROM in supine position 3) Protection of soft tissue surgical repairs, internal fixation, fractures, etc. when specific range of movement is desired by the physician/therapist; 4) Less pain levels experienced by the patient increasing confidence in the rehab process possibly reducing dependence on pain medication in the acute phases of rehab; 5) Supplement and compliment rehab efforts in the rehab setting; 6) Has applications in the home, inpatient, outpatient settings for a variety of diagnoses; 7) Less muscular contraction/guarding while trying to achieve normal glenohumeral motion; 8) Patients have control of range of motion based on their pain levels; 9) Improved home program performance due to less pain and observable objective gains in motion; 10) Prevention of complications such as stiff shoulder/frozen shoulder syndrome and better long term functional outcomes with “on-time” progression of AAROM/AROM/Strengthening/Functional Rehab/Recreational-Athletics.

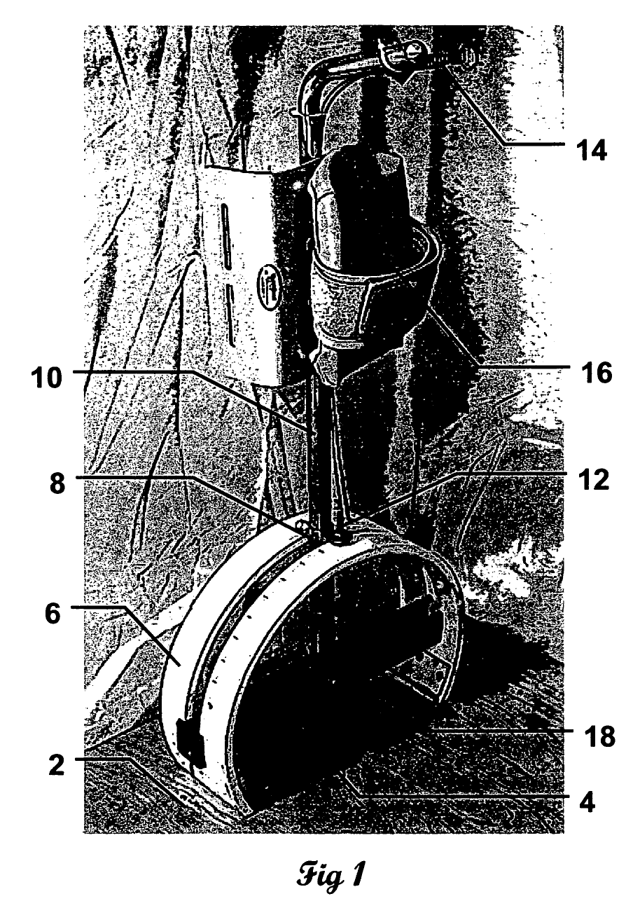

A preferred embodiment of the invention, as seen in FIG. 1, shows a base 2 and a frame 6 removably coupled with the base 2. This embodiment uses a wooden plywood base and a frame cut from a 12″ PVC pipe coupling. The frame 6 is attached to the base 2 using typical hinges having removable pins. A pivot arm support 4 is removably coupled with the frame 6 in two slots match-cut to the support profile, cut on opposite sides of the frame 6, and positioned such that the support 4 is elevated from the base 2 at approximately the height of the rotational axis of a patient's shoulder. A pivot arm 8 is removably coupled with the pivot arm support 4 at a hub 18 aligned with the rotational axis of a patient's shoulder. The pivot arm 8 has a stop device 12 that selectively engages with the frame 6 at preselected epicyclic intervals corresponding with a selected range of motion in a patient's shoulder. The stop device 12 is remotely controlled using a control cable 14 or other device for engaging the stop device 12. The stop device 12 can be a plunger, gear, clutch, pin, magnet, or solenoid. In one embodiment, the stop device uses a clutch positioned at the hub 18. The embodiment, in FIG. 1, uses a spring-loaded retractable plunger, TECO part no. 54301, attached to the pivot arm 8. The core of the plunger drops into holes drilled at preselected 100 increments around the 180° epicycle of the frame 6 thereby enabling shoulder rotations to start and stop in 10° increments and controlling the range of motion in a patient's arm. The patient pushes the control cable 14 to retract the stop device 12 (plunger) from a hole and releases the control cable 14 to engage the plunger at a fail-safe stop position. The patient can release the stop device at any time and the pivot arm will stop fail-safe into the next hole thereby avoiding shoulder injury. The patient, in consultation with a doctor, exercises in the proper range by blocking portions of the holes in the selected range of motion and/or inserting removable high/low limit stops at the desired motion. For example, if the desired range of motion is 20° to 40°, a removable high limit stop is placed in the 50° hole and a low limit stop is placed in the 10° hole thereby allowing the stop device and pivot arm to travel in the arc between 20° and 40°. A pivot arm extension 10 is removably coupled with the pivot arm 8 and has a forearm support 16 for strapping to a patient's right or left arm. The pivot arm extension 10 rotates inside the connection to the pivot arm 8 to allow proper fit, comfort and adjustment during shoulder rotation.

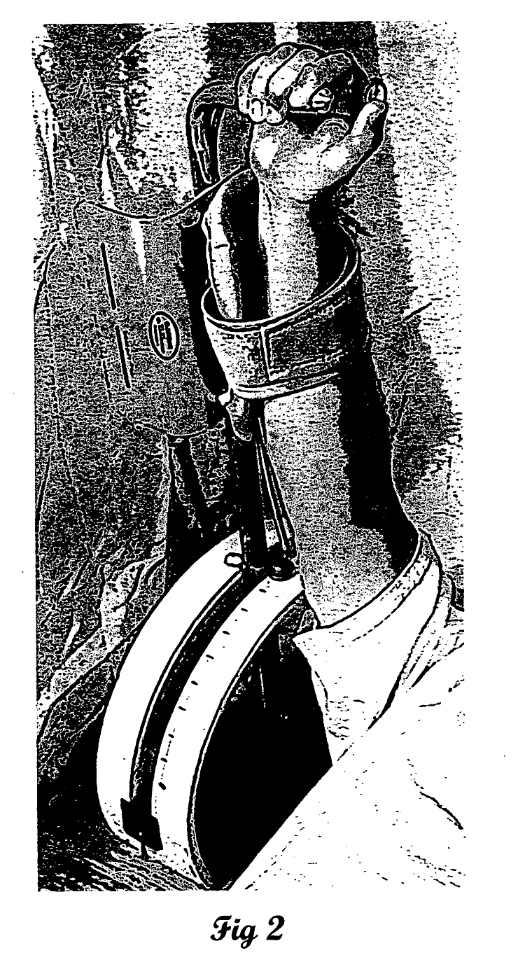

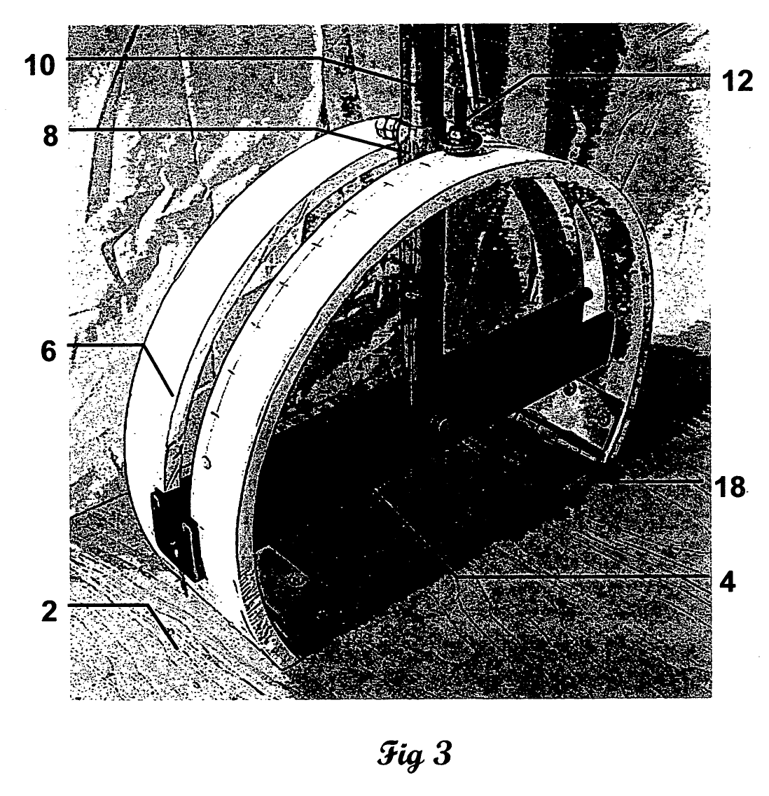

When the device is in any stop position, i.e. when the stop device is engaged at any angle, the patient can perform isometric exercises to strengthen shoulder and arm muscles that have been dormant during injury. The ISOROM will safely hold the arm stationary while the patient flexes various arm and shoulder muscles isometrically. These isometrics will improve patient recovery time. FIG. 2 shows a patients arm positioned in the ISOROM ready for therapy. FIG. 3 shows a close-up of the invention elements near the frame.

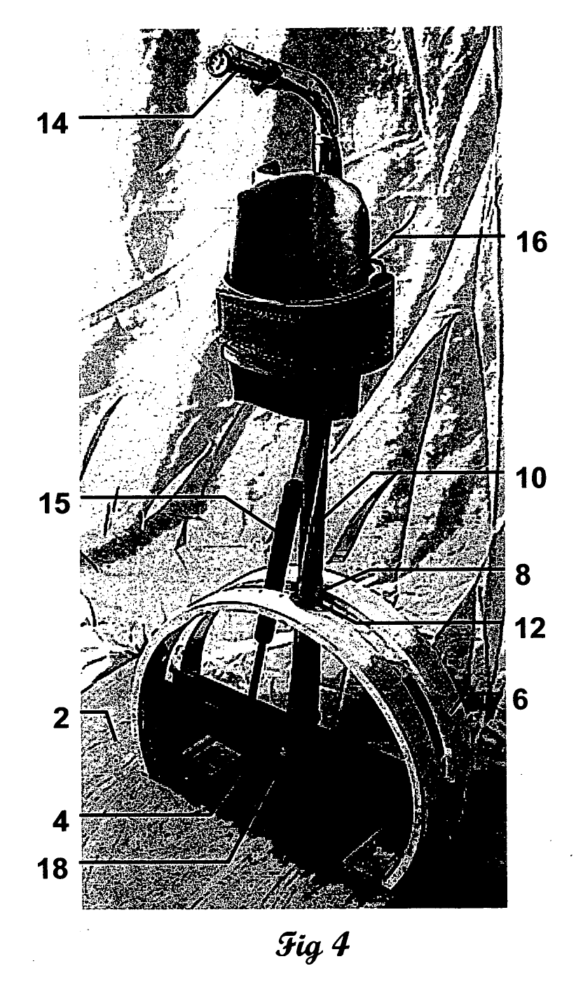

A second embodiment of the invention, as seen in FIG. 4, has similar features of the preferred embodiment plus a lifting member 15. The lifting member 15 is removably coupled at opposing ends with the pivot arm support 4 and the pivot arm extension 10. This embodiment uses a 24 lb. gas spring, SUSPA Model C16-09903, with ball-stud swivel end connections. The lifting member 15 assists the pivot arm extension 10 through the bi-directional arc motion during therapy. The gas spring provides both lift assistance and drop resistance for gradual and smooth motion of the device. The stop device 12 continues to function in the same manner controlling the ISOROM motion in preselected epicyclic intervals.

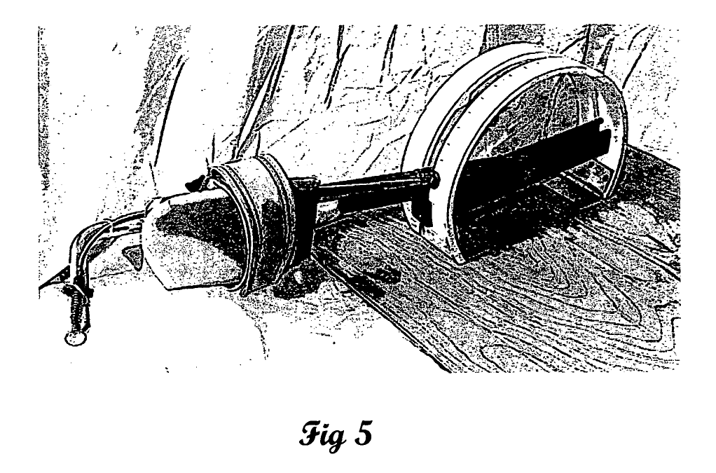

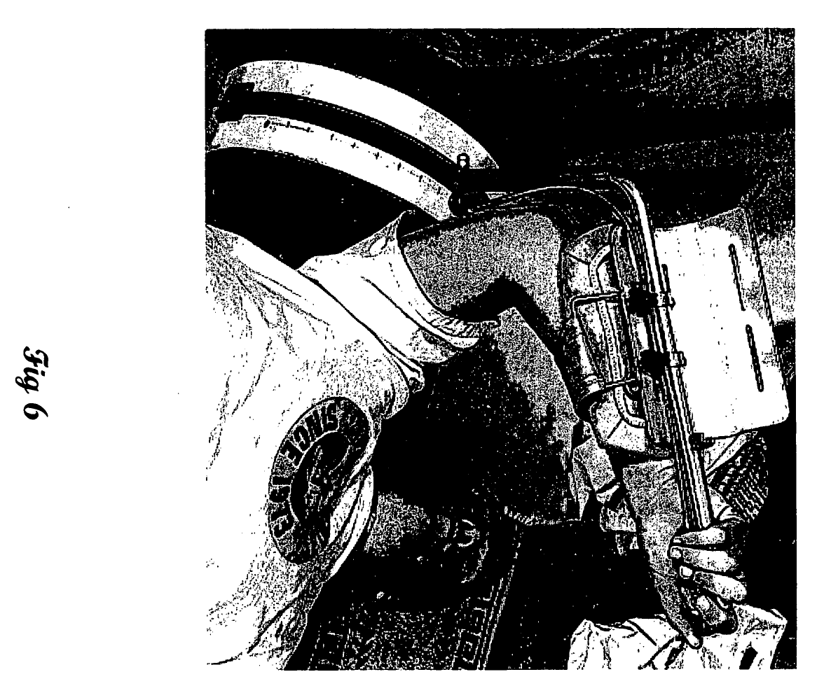

FIG. 4 shows a base 2 and a frame 6 removably coupled with the base 2. This embodiment also uses a wooden plywood base and a frame cut from a 12″ PVC pipe coupling. The frame 6 is attached to the base 2 using typical hinges having removable pins. A pivot arm support 4 is removably coupled with the frame 6 nesting in two slots match-cut to the pivot arm support profile, cut on opposite sides of the frame 6, and positioned such that the support 4 is elevated from the base 2 at approximately the height of the rotational axis of a patient's shoulder. A pivot arm 8 is removably coupled with the pivot arm support 4 at a hub 18 aligned with the rotational axis of a patient's shoulder. A lifting member 15 is removably coupled at opposing ends with the pivot arm support 4 and the pivot arm extension 10. The pivot arm 8 has a stop device 12 that selectively engages with the frame 6 at preselected epicyclic intervals corresponding with a selected range of motion in a patient's shoulder. The stop device 12 is remotely controlled using a control cable 14 or other device for engaging the stop device 12. The stop device 12 can be a plunger, gear, clutch, pin, magnet, or solenoid. In another embodiment, the stop device uses a clutch positioned at the hub 18. The embodiment, in FIG. 4, uses a spring-loaded retractable plunger, TECO part no. 54301, attached to the pivot arm 8. The core of the plunger drops into holes drilled at preselected 100 increments around the 180° epicycle of the frame 6 thereby enabling shoulder rotations to start and stop in 10° increments and controlling the range of motion in a patient's arm. The patient pushes the control cable 14 to retract the stop device 12 (plunger) from a hole and releases the control cable 14 to engage the plunger at a fail-safe stopped position. The patient can release the stop device at any time and the pivot arm will stop fail-safe into the next hole thereby avoiding shoulder injury. The gas spring provides both lift assistance and drop resistance for gradual and smooth motion of the ISOROM. The patient, in consultation with a doctor, exercises in the proper range by blocking portions of the holes in the selected range of motion and/or inserting removable high/low limit stops at the desired motion. For example, if the desired range of motion is 20° to 40°, a removable high limit stop is placed in the 50° hole and a low limit stop is placed in the 10° hole thereby allowing the stop device and pivot arm to travel in the arc between 20° and 40°. A pivot arm extension 10 is removably coupled with the pivot arm 8 and has a forearm support 16 for strapping to a patient's right or left arm. The pivot arm extension 10 rotates inside the connection to the pivot arm 8 to allow proper fit, comfort and adjustment during shoulder rotation. FIG. 5 shows the ISOROM in a 0° position with the gas spring retracted. FIG. 6 shows a patient positioned for therapy with the pivot arm extension having an adjustable elbow portion aligned with the bent patient elbow for comfort and support.

The current invention has been shown and described herein in what is considered to be the most practical and preferred embodiments. It is recognized, however, that departures may be made therefrom within the scope of the invention and that obvious modifications will occur to a person skilled in the art.

I claim:

1. A portable isorom device comprising:
a base,
a frame removably coupled with said base,
a pivot arm support removably coupled with said frame,
a pivot arm removably coupled with said pivot arm support and selectively engaged with said frame at preselected epicyclic intervals corresponding with a range of motion in a supine patient's shoulder, and
a pivot arm extension removably coupled with said pivot arm.

2. The portable isorom device of claim 1 wherein said pivot arm is selectively engaged with said frame using at least one stop device selected from the group consisting of plunger, gear, clutch, pin, magnet, and solenoid.

3. The portable isorom device of claim 2 wherein said pivot arm extension further comprises a remote control device to operate said stop device.

4. The portable isorom device of claim 3 wherein said remote control device is at least one device selected from the group consisting of throttle cable, thumb cable, and control cable.

5. The portable isorom device of claim 1 wherein said pivot arm extension further comprises a forearm support.

6. The portable isorom device of claim 1 wherein said pivot arm is removably coupled with said pivot arm support at a hub aligned with the rotational axis of said patient shoulder.

7. The portable isorom device of claim 6 wherein said hub further comprises a clutch.

8. The portable isorom device of claim 1 wherein said coupling of said pivot arm extension with said pivot arm is adjustable.

9. The portable isorom device of claim 1 wherein said pivot arm extension rotates around its center axis in alignment with said pivot arm.

10. The portable isorom device of claim 1 wherein the full length of said pivot arm extension is aligned axially with said pivot arm.

11. The portable isorom device of claim 1 wherein said pivot arm extension further comprises an adjustable elbow portion aligned with a patient elbow.

12. A portable isorom device comprising:
a base,
a frame removably coupled with said base,
a pivot arm support removably coupled with said frame,
a pivot arm removably coupled with said pivot arm support and selectively engaged with said frame at preselected epicyclic intervals corresponding with a range of motion in a supine patient's shoulder,
a pivot arm extension removably coupled with said pivot arm, and
a lifting member removably coupled with said pivot arm support and said pivot arm extension wherein said lifting member assists said pivot arm extension through bidirectional motion at said preselected epicyclic intervals.

13. The portable isorom device of claim 12 wherein said pivot arm is selectively engaged with said frame using at least one stop device selected from the group consisting of plunger, gear, clutch, pin, magnet, and solenoid.

14. The portable isorom device of claim 12 wherein said pivot arm extension further comprises a remote control device to operate said stop device.

15. The portable isorom device of claim 14 wherein said remote control device is at least one device selected from the group consisting of throttle cable, thumb cable, and control cable.

16. The portable isorom device of claim 12 wherein said pivot arm extension further comprises a forearm support.

17. The portable isorom device of claim 12 wherein said pivot arm is removably coupled with said pivot arm support at a hub aligned with the rotational axis of said patient shoulder.

18. The portable isorom device of claim 17 wherein said hub further comprises a clutch.

19. The portable isorom device of claim 12 wherein said coupling of said pivot arm extension with said pivot arm is adjustable.

20. The portable isorom device of claim 12 wherein said pivot arm extension rotates around its center axis in alignment with said pivot arm.

21. The portable isorom device of claim 12 wherein the full length of said pivot arm extension is aligned axially with said pivot arm.

22. The portable isorom device of claim 12 wherein said pivot arm extension further comprises an adjustable elbow portion aligned with a patient elbow.

23. The portable isorom device of claim 12 wherein said lifting device is at least one device selected from the group consisting of a gas spring, mechanical spring, tension bands, and electric motor.
